(19) United States
(12) Patent Application Publication
(10) Pub. No.: US 2006/0198934 A1
(43) Pub. Date: Sep. 7, 2006

(54) Process for removing flatulence-associated oligosaccharides in legumes

(75) Inventors: James R. Wilson, Riverside, CA (US); Marvin A. Payne, Riverside, CA (US); Dikran R. Rakijian, Carlsbad, CA (US); Ronald S. O. Zane, Riverside, CA (US)

Correspondence Address: BIO TECHNOLOGY LAW GROUP;C/O PORTFOLIOIP, PO BOX 52050, MINNEAPOLIS, MN, 55402, US

(73) Assignee: Ronald S.O. Zane, Riverside, CA (US)

(21) Appl. No.: 11/365,002

(22) Filed: Feb. 28, 2006

Related U.S. Application Data
(60) Provisional application No. 60/657,614, filed on Mar. 1, 2005.

(51) Int. Cl. B02B 1/08

(52) U.S. Cl. 426/507

(57) ABSTRACT

A simple process for reducing or eliminating oligosaccharides from foodstuffs, particularly legumes, is described and claimed, as well as are the resulting products. The process makes use of a hydration, followed by salination, followed by desalination and optionally further employs one or more antimicrobials and antioxidants to preserve organoleptic qualities.

### RELATED APPLICATIONS

This application claims priority to and incorporates herein by reference the entirety of U.S. Provisional Patent Application Ser. No. 60/657,614, filed Mar. 1, 2005, entitled the same.

### FIELD OF THE INVENTION

The field of the invention relates to food science technology, particularly as applied to legumes and the negation, neutralization, conversion, minimization or elimination of flatulence-associated oligosaccharides in legumes.

### BACKGROUND ART

Flatulence in humans is most often the result of ingesting foods containing the oligosaccharides raffinose, stachyose and verbascose. Together with fructose and sucrose these oligosaccharides represent the major reserves of soluble carbohydrates in seeds that are mobilized during the very early stages of germination. During maturation of bean seeds, sucrose and fructose content decrease while the content of raffinose, stachyose and verbascose increase. Alpha-galactosidase and sucrase are two endogenous enzymes that hydrolyze these oligosaccharides to monosaccharides, which monosaccharides can then be readily absorbed into the bloodstream. Many individuals cannot degrade these oligosaccharides. Instead, the un-hydrolyzed oligosaccharides are fermented by microorganisms present in the colon and produce bi-product gases such as carbon dioxide, hydrogen and methane that manifest as unpleasant flatulence. This problem is not confined to humans. It also occurs in other animals, most notably cattle.

Various treatments have been proposed to remove oligosaccharides from legumes, including the use of enzymes, leaching and sprouting to enhance oligosaccharide digestibility or otherwise lessen or negate their ability to cause flatulence. For example, U.S. Pat. No. 3,632,346 issued to Sherba reports rendering flatulence-producing saccharides innocuous by enzyme-mediated hydrolysis. U.S. Pat. No. 4,376,128 issued to Lunde reports similar methodology.

U.S. Pat. No. 4,645,677 issued to Lawhon et al. reports removal of flatulence-causing sugars from bean products through ultrafiltration of particulate suspensions.

U.S. Pat. No. 5,863,591 issued to Seguin reports shortening the cooking time of dried legumes by subjecting to a short-timed, high-pressure, hydration.

U.S. Pat. Nos. 5,871,801 and 6,274,189, both issued to Kazemzadeh, report producing reduced-flatulence, legume-based snack foods by hydrating in an aqueous solvent containing processing aids, followed by comminuting and extracting out the responsible carbohydrates by pressing the legume into “press cakes”.

U.S. Pat. Nos. 6,238,725 and 6,465,031, both issued to Bush et al., report removing flatulence-causing oligosaccharides in legumes by hydrating and leaching at successively stepped temperatures that avoid innate enzyme degradation. U.S. Pat. Nos. 6,355,291 and 6,602,534, both issued to Rose et al., report similar methodology, as does Revilleza et al. Abstract, Plant Foods for Human Nutrition, 40(1):83-93 (1990).

Other reports consistent with the foregoing may be found, e.g., in U.S. Pat. Nos. 3,958,015, 5,989,544, 5,902,617, 5,773,427, 5,651,967, 5,445,957, and 5,436,003, as well as in published US Application 20020127283.

While the foregoing methods may be more or less effective in reducing flatulence, they also more or less tend to compromise the quality, integrity and organoleptic properties of the final product. From the standpoint of enzyme usage and temperature hikes, the foregoing methods also translate to increased expense. There is thus a need for simpler, cost-effective methodologies that result in high-quality end product.

### SUMMARY OF THE INVENTION

The present invention ameliorates one or more of the above problems and prior art shortcomings. In general terms, the invention features reduced flatulence-associated oligosaccharides in a food-stuff, preferably in plant matter, and more preferably still in a legume, by using a hydration step followed by a salination step, followed in turn by de-salination. The steps usually take place in sequence but may be preceded, followed, or interposed with one or more additional steps and/or components consistent with the goal of lessening or negating the unpleasant effects of flatulence-associated oligosaccharides, while seeking to preserve organoleptic properties of the end product.

In a first aspect, the invention features a method of reducing the amount of flatulence-associated oligosaccharides in a food-stuff. Preferably the foodstuff is a legume. Illustrative legumes and foodstuffs include but are not limited to pinto beans, navy beans, great northern white beans, soybeans, lentils, pink beans, red beans, black beans, navy beans, black eye beans, kidney beans, garbanzo beans, fava beans, lentils, peas, cabbage and brussel sprouts.

Hydration may be by any means or combination of means, e.g., use of soaking, steaming, pressure, etc. and may be to any positive degree or fraction thereof of moisture content relative to the pre-hydration starting material, preferably achieving a moisture content of about 25 to about 50% by weight. In preferred embodiments, hydration is performed by soaking and to substantial completion, meaning that the food-stuff is saturated or nearly saturated with water. In preferred embodiments, the soak is preferably performed at temperatures less than about 50° C., preferably at between about 4° C. and about 50° C., more preferably between about 20° C. and about 40° C., and most preferably at about 40° C. for about 6 hours (pinto beans). The person of ordinary skill appreciates that the precise soak times and temperatures can vary, particularly as between species and depend on variables such as mass of the food-stuff, soak volume, pressure, amount of mechanical mixing employed, “hardness” or “softness” of the water employed and the amount of oligosaccharides desired to be removed. Water used may be any type, e.g., tap, well, filtered, distilled, de-ionized, soft, hard or any combination thereof that is of sufficient nature to hydrate the subject food-stuff. Preferably the water is purified and contains no to low overall salt, e.g., 0.5% w/v or less. Preferably the pH of the water is in the range of about 6 to 7.5. This too can vary with temperature and the presence of other components in the water.

Once hydration is complete, the foodstuff is soaked in a salt solution. The residual hydrating water can first be drained or emptied, in which case a salt solution is then added in sufficient volume to soak the foodstuff. Alternatively, whatever remains of the hydrating water can be left in and to it added aqueous and/or dry salt. Either way, the foodstuff is soaked in a salt solution, preferably at an initial concentration of least about 1% w/v, preferably 1-25%, and more preferably still about 3-8%, and more preferably 5-8%. The salt can be of one type or a combination of types and is preferably selected from the group consisting of NaCl, KCl, and CaCl₂, although many different types exist that can be used. Preferred is NaCl because of its abundance and proven biochemical acceptability and affordability. Soak times and temperature can vary, but a 1 to 24 hour soak, more preferably about 10 hours, at between about 20 and 50° C. is preferred, most preferably at about 40° C.

Following the soak in salt solution, the salt solution or a portion thereof is then removed and/or vastly diluted with a lower salinity aqueous solution, e.g., distilled, deionized water or tap water. Preferably the salt solution is replaced with stagnant or flowing rinses of water, preferably de-ionized, distilled or tap water. Preferably this is done at about 20 to 50° C., most preferably at about 40° C., and preferably under perpetually replenished flowing water for between about 1 and about 24 hours. The term “replacing” in the claim phrase “lowering the salinity of said salt solution by replacing” may include replacing any portion of the original salt solution. Likewise, the claim term “diluting with a lower salinity solution” may encompass diluting any portion, volume or amount of the original salt solution such that the overall salt concentration of the soaking solution is lowered. Thus, the overall phrase “lowering the salinity of said salt solution by replacing or diluting with a lower salinity solution” contemplates both complete replacement or dilution and fractional replacement or dilution, with the end objective being the lowering of salinity in the solution in which the beans are being soaked.

In one or more of the preceding steps, one or more antimicrobial agents can be included in the soaking solution. A preferred antimicrobial agent is sodium hypochlorite (NaOCl), preferably used at a final concentration of about 0.0003% to about 0.15% w/v, and more preferably at a final concentration of between about 0.0006% and 0.01% w/v.

In one or more the preceding steps, one or more antioxidants can also be employed. A preferred antioxidant is citric acid used at a final concentration of between about 0.001% and 1% w/v, more preferably at a final concentration between about 0.01% and 0.05% w/v.

In addition to the preceding steps and components, exogenous enzymes can be added that hasten oligosaccharide removal or elimination.

Any of the preceding embodiments can be combined as appropriate in furtherance of the invention objectives.

In a second aspect, the invention features in a method for reducing or eliminating oligosaccharides from a foodstuff, preferably a legume, the use in tandem of an antioxidant and antimicrobial. Citric acid is a preferred antioxidant, preferably at a working concentration of 0.001% to 1%, more preferably 0.01% to 0.05%. Sodium hypochlorite is a preferred antimicrobial, preferably at a working concentration of 0.0006% to 0.01%, preferably 0.005%.

In a third aspect, the invention features a foodstuff made according to the preceding aspects and embodiments. The foodstuff can be for humans or animals, e.g., cattle, and is preferably plant-based in origin, more preferably legume-based. Preferred legumes and foodstuffs include but are not limited to beans, e.g., navy, pinto and/or soy beans, and cabbage.

As used herein and in the claims with respect to numerical values immediately following or adjacent the terms “approximately” or “about,” these terms are synonymous and embrace values 10% below or above the specific number denoted. For example, the term “approximately 3-4 volumes” or “about 3-4 volumes” includes the range of volumes 2.7 to 4.4. Similarly, the term “about 1%” embraces each of the values 0.9% and 1.1%.

Again, the advantages of the invention include, depending on precise embodiment, efficient, simplistic and cost-effective elimination, reduction or inactivation of oligosaccharides in foodstuffs so as to thwart or lessen consumer flatulence. In addition, some embodiments feature superior organoleptic qualities, e.g., taste and texture, of the end product.

Further aspects and embodiments will be apparent to the person of ordinary skill from the detailed description of preferred embodiments and claims to follow.

### BRIEF DESCRIPTION OF THE DRAWINGS

FIG. 1 is a bar graph showing percent removal of raffinose series oligosaccharides (RSO) from each of soy, pinto, navy, and black beans using one embodiment of the invention.

### DETAILED DESCRIPTION OF THE PREFERRED EMBODIMENTS

Applicants have found that a very simple procedure can be used to extract flatulence-causing oligosaccharides from foodstuffs, particularly legumes. This has a variety of useful implications for food processing, whether the food be for humans or for animals such as cattle. Flatulence is a significant problem not confined to humans.

The method makes use of a hydration, followed by salination, followed by desalination of the foodstuff. By employing these steps, Applicants observe a significant lessening or elimination of the oligosaccharides that give rise to fermentation in the intestines, which in turn manifests as flatulence.

Legumes in particular are noted for their oligosaccharide content and consequent ability to engender flatulence. The oligosaccharides within the legume seeds are released upon structural disruption of the legume, such as occurs upon eating. To control their unsavory effects while in the gut, the oligosaccharides should be eliminated or inactivated in advance of eating. Earlier attempts at this included heating, leaching, enzymatic degradation, and combinations of these. Unfortunately, many of these compromise the organoleptic qualities of the legume and thus make them less palatable and desirable for the end user.

Heating is problematic in that if too high it compromises the structural integrity, texture and taste of the food. If not too high as to compromise structural integrity, warm temperatures allow the endogenous enzymes responsible for oligosaccharide breakdown to be active, but at the same time growth of contaminating microbes is promoted, which produces the metabolic bi-product lactic acid. Lactic acid in legumes manifests as an undesirable bitter taste. Rancidity may also occur. Rancidity denotes chemical deterioration of fat by either of two chemical processes-oxidation or hydrolysis of lipids (lipidolysis). This too manifests as an unpleasant taste, as well as smell. Processes that employ lower temperatures are therefore desirable, although not obligatory to the invention, as are processes that otherwise thwart lipid oxidation and microbe growth.

To control microbial growth, Applicants have found it useful to employ the antimicrobial compound sodium hypochlorite (NaOCl) in one or more of the hydration, salination and desalination steps. This essentially lowers the microbial content to an innocuous level when employing 0.0006% to 0.01%. It is anticipated that other antimicrobial compounds known in the art can be used, e.g., calcium hypochlorite (Ca(OCl)₂), and one of ordinary skill will appreciate that the effective concentrations of these may vary versus NaOCl but can be determined by one of ordinary skill without undue experimentation.

To control oxidative and hydrolytic rancidity, Applicants have found it useful to employ 0.001% to 1% citric acid, preferably 0.01% to 0.05%, in one or more of the hydration, salination and desalination steps. It is anticipated that other antioxidants well known in the food sciences arts will bode similar utility in the process, and that effective concentrations of these may vary relative to citric acid but can be determined by one of ordinary skill without undue experimentation. Illustrative antioxidants besides citric acid include but are not limited to tertiary-butylhydroquinone (TBHQ), butylated hydroxyanisole (BHA), butylated hyroxytoluene (BHT), and propyl gallate (PG).

Hydration, salination and desalination all implicate the related principles of osmosis and diffusion. Both principles relate to the tendency of something to flow from a higher concentration to a lower concentration until equilibrium is established. Osmosis is defined as water movement from a higher concentration to a lower concentration across a semi-permeable membrane, e.g., a cellular membrane. Diffusion denotes solute movement from a higher concentration to a lower concentration, again usually across a semi-permeable membrane. Diffusion of solutes is dependant on a number of factors, including but not limited to time, temperature, size and charge of solute. With respect to biological membranes, the solute and solvent concentration differential that exists on one side of the membrane relative to the other drives the respective processes of osmosis and diffusion, which run counter-current to one another.

Hydration

In the broadest sense, all that is necessary for the foodstuff to hydrate is to use a water concentration on the outside of the foodstuff that is greater than that on the inside of the foodstuff. The water on the outside need not be pure, although in some preferred embodiments is, and may contain solutes, e.g., salts, minerals, etc., as long as a directional water flow into the foodstuff is achieved. Soaking is one way of hydrating. Steaming is another. The two can also be combined. Hydration according to the invention can also be achieved to varying degrees but is most preferably performed to maximal or close to maximal saturation of the foodstuff.

Salination

Salination is accomplished when salt is introduced into something—here a foodstuff. To accomplish this, the foodstuff is typically immersed and soaked in a salt solution having a higher concentration of salt than exists in the foodstuff. The foodstuff, via diffusion, absorbs some of the salt from the saline solution in which it is immersed. Optimum salt concentration in the salt solution is at least about 1% w/v, preferably 1-25% w/v, with the latter approaching the solubility limit for many salts, and more preferably about 3-8%, preferably 5-8%. Although use of many different salts and combinations thereof can be used in the salination step of the invention, it is most practical to use the abundant, affordable and safe salt, NaCl.

Desalination

Desalination is akin to hydration insofar as the water concentration on the outside is higher than that on the inside of the foodstuff. Desalination also contemplates reversal of a higher concentration of salt on the inside relative to the outside. Again, any purity or form of water or mode of introduction and interfacing with the foodstuff can be used in accordance with the invention as long as the objective of reducing salt in the foodstuff is achieved. Applicants hypothesize that oligosaccharides tend to follow the salts out of the foodstuff during the desalination step.

General Considerations

The steps in the present inventive process may be performed in batch or continuous mode and scaled up or down as appropriate to suit the desired end. Each step may also be configured as a stagnant or continuous flow step. For stagnant steps it may be useful to repeat the soak by withdrawing the foodstuff from the previous soak and placing in a fresh soak solution. In continuous flow configurations, the soak volume can be maintained while the water/solution is circulated and thereby made fresh. Old solution can be withdrawn at a rate similar to the introduction rate of new solution.

Further, while the invention may make use of a comminuted foodstuff, another advantage for some embodiments of the invention is that the process is rendered on a whole foodstuff, such that the integrity of that foodstuff is largely preserved and hence at least visibly appealing to the consumer. One particular application for legumes that bodes imminent utility is, following the inventive procedures stated herein, crushing or pressing and dehydrating the whole legumes, such that the legumes easily reconstitute upon hydration/frying, have good texture and organoleptic qualities, but also offer fewer flatulence-promoting polysaccharides. Cleaning, preconditioning, cooking, flaking and dehydration technology is now common knowledge in the art and can be readily used in conjunction with the product produced by the present invention. See, e.g., U.S. Pat. Nos. 6,090,433, 4,871,567, and 4,735,816, issued to Sterner et al., the disclosures of which are herein incorporated by reference. These additional steps can also be used in addition to the hydration, salination, and desalination steps of the invention, provided in furtherance of one or more of the invention objectives.

Measuring Oligsaccharide Concentrations

Oligosaccharides can be measured using standard methodologies, e.g., water-ethanol extraction techniques followed by one or more types of spectrophotometry or chromatography, e.g., HPLC or HPTLC. See U.S. Pat. No. 6,146,669; Revilleza et al. (1990), Plant Food for Human Nutrition 40:83-93; Saini, H. S. and Knights, J. K. (1984), J. Agric. Food Chem., 32 940; Sosulski et al. (1982), J. Food Sci. 47:498-502; Jeffrey et al. (1969) J. Chromatog. 41:475-80; Shallenberger, R. S. and Moyer, J. C. (1961) J. Agric. Food Chem., 9, 1372.

Various commercially available reagent kits can facilitate these measurements, e.g., the “Raffinose-Series Oligosaccharides Assay Procedure” kit offered by Megazyme (Wicklow, Ireland; see also www.megazyme.com;), which Applicants employed as discussed herein to demonstrate their invention. The kit is predicated on the principle that raffinose-series oligosaccharides are hydrolyzed to galactose, glucose and fructose using alpha-galactosidase and invertase. The glucose concentration is measured using glucose oxidase/peroxidase reagent. Glucose is a surrogate marker for the other sugars because of its constant stoichometric ratio in raffinose-series oligosaccharides.

### EXAMPLES

The specific protocols below were all optimized using commercially available identity-preserved Maverick variety pinto beans, and “commingled” varieties for each of navy beans, black beans and soy beans, with starting moisture content varying from about 10-25%. The protocols can be differentiated to fit the specific identity and metabolic character of other foodstuffs and legumes to expedite removal of oligosaccharides. For each of pinto, soy and navy beans Applicants have found the basic process reproducible across a broad spectrum of starting material weights, e.g., from gram scale to 500 lb. commercial scale quantities.

### Example 1

### Hydration

Beans are rinsed with de-ionized, distilled or tap water, most preferably tap water, and then soaked in approximately 3-4 volumes of stagnant or flowing water at 20° C. to 50° C. for 1 to 10 hours, most preferably at 40° C. for 6 hours.

### Example 2

### Salination

The hydrated beans are then soaked in approximately 3-4 volumes of a 1% to 25% w/v salt solution, preferably a NaCl solution, for 1 to 24 hours at 20° C. to 50° C., most preferably a 5% NaCl solution for 10 hours at 40° C.

### Example 3

### Desalination

The salinated beans are desalinated in stagnant or flowing rinses of de-ionized, distilled or tap water at 20° C. to 50° C. for 1 to 24 hours, most preferably in flowing tap water at 40° C. for 8 hours or until the desired amount of oligosaccharides have been removed. When stagnant water is used, Applicants have found desalination soak volumes of approximately 3-4× that of the volume or weight of the beans useful. For example, one soak may be performed for two hours followed by water replacement and an additional soak for three hours.

### Example 4

### Oligosaccharide Measurement

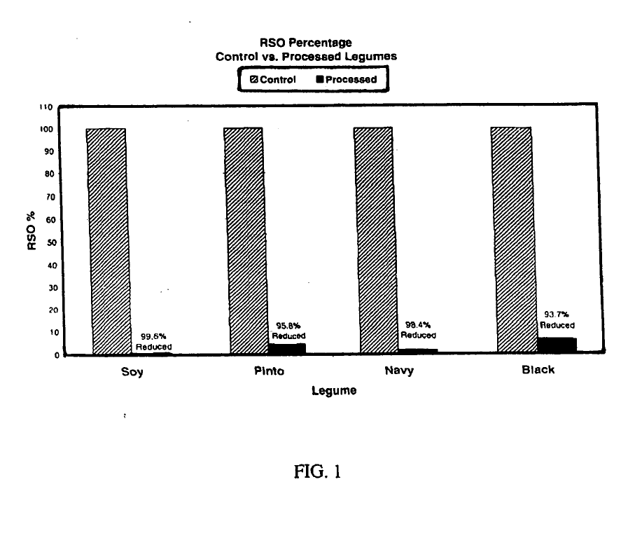

Legumes are removed from the desalination solution of Example 3 and oligosaccharide measurement then made using a Megazyme “Raffinose-Series Oligosaccharides Assay Procedure” and kit. Briefly, 5 ml of ethanol (95% v/v) was added to each of 0.50 gm of sample, positive and negative controls in separate glass test tubes and incubated at 84-88° C. in a water-bath and allowed to reflux for 5 minutes to inactivate endogenous enzymes. The tube contents were then transferred to 50 ml volumetric flasks and the volumes adjusted to the 50 ml mark with sodium acetate buffer (50 mM, pH 4.5) (Buffer 1). The samples were allowed to extract over 15 minutes and the slurry was thoroughly mixed. Five (5.00) ml aliquots of the slurries were then transferred to glass test tubes suitable for centrifugation at 1,000×g and 2 ml of chloroform added to each, mixed vigorously on a vortexer for 15 seconds and then centrifuged at 1,000×g for 10 minutes. Three 0.2 ml aliquots were taken of the upper aqueous solutions (Solution A) of each sample and control. To these were added, respectively, 0.2 ml Buffer 1 [glucose], 0.2 ml of 10 U/ml invertase [sucrose+glucose], and 0.2 ml of 50 U/ml alpha-galactosidase+10 U/ml invertase [glucose+sucrose+raffinose-series oligosaccharides] and each was then incubated at 50° C. for 20 minutes. To each (as well as a Reagent Blank and Controls as explained in the kit) was then added 3.0 ml of Glucose Determination Reagent (12,000 U/liter glucose oxidase, >650 U/liter peroxidase, and 0.4 mM 4-Aminoantipyrine), the mixes then incubated at 50° C. for 20 min, and absorbances taken at 510 nm on a Beckman DU640 UV/VIS spectrophotometer for each sample as measured against a Reagent Blank. Results for typical batches of soy, pinto, navy and black beans are shown in FIG. 1.

The foregoing invention aspects and embodiments are illustrative only and not intended to be limiting of the claimed inventions. One skilled in the art will readily appreciate that the present invention, depending on embodiment, is well adapted to carry out the objects and advantages discussed. The terms and expressions which have been employed are used as terms of description and not of limitation, and there is no intention in the use of such terms. It should be understood that although the present invention has been specifically disclosed by preferred embodiments, optional features, modification and variation of the concepts herein disclosed may be resorted to by those skilled in the art, and that such modifications and variations are considered to be within the scope of this invention.

The invention illustratively described herein suitably may be practiced in the absence of any element or elements, limitation or limitations which is not specifically disclosed herein. Thus, for example, any of the transitional claim terms “comprising”, “consisting essentially of” and “consisting of” may be replaced with one another to afford a different meaning to the claim under the patent laws.

The disclosures of all documents and publications cited herein are hereby incorporated by reference in their entireties, although none is admitted to be prior art.

All ingredients and hardware used in the processes described above are known and available commercially or else readily acquired and/or produced without undue experimentation according to standard methodologies and sources within the art.

Where features or aspects of the invention are described in terms of Markush groups or other grouping of alternatives, those skilled in the art will recognize that the invention is also thereby described in terms of any individual member or subgroup of members of the Markush group or other group, and exclusions of individual members as appropriate.

1. A method of reducing the amount of flatulence-associated oligosaccharides in a legume, the method comprising:
(a) hydrating a legume with water;
(b) soaking the hydrated legume of step (a) in a salt solution, said salt solution comprising at least about 1% w/v salt; and
(c) lowering the salinity of said salt solution by replacing or diluting with a lower salinity solution for sufficient time to reduce the amount of flatulence-associated oligosaccharides in said legume.

2. The method of claim 1 wherein said hydrating increases the weight of the starting legume from about 50% to about 100% from its original dry weight, to yield a legume that is 25% to 50% water by weight.

3. The method of claim 1 wherein said salt comprises one or more members selected from the group consisting of NaCl, KCl, and CaCl₂.

4. The method of claim 1 wherein said legume in step (b) is soaked in said salt solution for between about 1 and 24 hours.

5. The method of claim 1 wherein one or more of steps (b)-(c) is performed at between about 4° C. and about 50° C.

6. The method of claim 1 wherein said hydrated legume is 1% to 100% greater in weight than prior to said hydration.

7. The method of claim 1 wherein the hydrated legume produced by step (a) is hydrated to substantially full hydration capacity.

8. The method of claim 1 wherein one or more of said steps are employed in the presence of one or more of an antimicrobial agent and antioxidant.

9. The method of claim 8 wherein said antimicrobial agent comprises sodium hypochlorite and said anti-oxidant comprises citric acid.

10. The method of claim 8 wherein said antimicrobial agent is present at about 0.0003% to about 0.15% w/v.

11. The method of claim 8 wherein said antioxidant is present at about 0.001% to about 1.0% w/v.

12. The method of claim 1 wherein said salt comprises one or more members selected from the group consisting of NaCl, KCl, and CaCl₂, said legume in step (b) is soaked in said salt solution for between about 1 and 24 hours, one or more of steps (b)-(c) is performed at between about 4° C. and about 50° C., said hydrated legume is at least 1% greater in moisture content than prior to said hydration, and wherein optionally one or more of said steps are employed in the presence of one or more of an antimicrobial agent and antioxidant.

13. The method of claim 12 wherein said antimicrobial agent comprises sodium hypochlorite and said anti-oxidant comprises citric acid.

14. The method of claim 12 wherein said salt is present at a concentration of between about 5% and 8% w/v.

15. The method of claim 12 wherein said sodium hypochlorite, if present, is present at about 0.0003% to about 0.15% w/v and wherein said citric acid, if present, is present at about 0.001% to about 1.0% w/v.

16. The method of claim 1 wherein said legume is selected from one or more members in the group consisting of soybean, pinto bean, black bean and navy bean.

17. The method of claim 1 wherein said legume is present in a plurality of the same species of legume.

18. The method of claim 1 wherein said legume is present in a plurality of different species of legume.

19. A processed legume produced according to the method of claim 1.

20. The processed legume of claim 19, further processed according to the method of claim 12.
